(19) United States
(12) Patent Application Publication
(10) Pub. No.: US 2024/0134705 A1
(43) Pub. Date: Apr. 25, 2024

(54) ADJUSTING WORKLOAD EXECUTION BASED ON WORKLOAD SIMILARITY

(71) Applicant: Intel Corporation, Santa Clara, CA (US)

(72) Inventors: Niranjan Hasabnis, San Jose, CA (US); Patricia Mwove, Chandler, AZ (US); Ellick Chan, Portland, OR (US); Derssie Mebratu, Hillsboro, OR (US); Kshitij Doshi, Tempe, AZ (US); Mohammad Hossain, Santa Clara, CA (US); Gaurav Chaudhary, Santa Clara, CA (US)

(73) Assignee: Intel Corporation, Santa Clara, CA (US)

(21) Appl. No.: 18/538,852

(22) Filed: Dec. 13, 2023

(51) Int. Cl. G06F 9/50

(52) U.S. Cl. CPC G06F 9/505; G06F 9/5016

(57) ABSTRACT

Adjusting workload execution based on workload similarity. A processor may determine a similarity of a first workload to a second workload. The processor may adjust execution of the first workload based on execution parameters of the second workload and the similarity of the first workload to the second workload.

### BACKGROUND

Execution of workloads may vary across different systems. Furthermore, execution of different workloads may vary across the same and/or different systems. Further still, the execution of one workload may affect the execution of another workload sharing the same computing hardware.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of a telemetry architecture in accordance with one embodiment.

FIG. 2 illustrates a system in accordance with one embodiment.

FIG. 3 illustrates an embodiment of adjusting workload execution based on workload similarity.

FIG. 4A illustrates a training phase 400 in accordance with one embodiment.

FIG. 4B illustrates a deployment phase 402 in accordance with one embodiment.

FIG. 5 illustrates an aspect of the subject matter in accordance with one embodiment.

FIG. 6 illustrates a logic flow 600 in accordance with one embodiment.

FIG. 7 illustrates a system in accordance with one embodiment.

### DETAILED DESCRIPTION

Embodiments disclosed herein may adjust execution of a workload based on workloads that are similar to the workload. For example, if a first workload is similar to a second workload, execution parameters associated with the second workload may be used to adjust the execution of the first workload. For example, the execution parameters associated with the second workload may include a first number of processor threads, while execution parameters of the first workload may include a second number of processor threads (where the first number of processor threads is different than the second number of processor threads). As such, the execution parameters of the first workload may be adjusted to allocate the first number of processor threads to the execution of the first workload. More generally, any number and/or type of execution parameters of a workload may be adjusted based on workload similarity. Embodiments are not limited in these contexts.

In some embodiments, the workloads may be represented as vectors in a vector space. In some embodiments, the vectors are embedding vectors. Such vectors may facilitate the comparison of workloads. For example, the vectors may reflect behaviors of different facets of executing the workloads such that the workloads can be compared. More generally, the generation of vectors may act as a dimensionality reduction technique to process numerous attributes of the workloads (e.g., performance counters, etc.), where some workload attributes may be correlated. Doing so allows the workloads to be compared using fewer computing resources relative to comparing each individual attribute and/or parameter of different workloads.

In some embodiments, a model (e.g., a neural network) may be trained based on training data that includes a plurality of training workloads, where each respective training workload is associated with a set of execution parameters (e.g., resource configurations) and performance metrics corresponding to each set of execution parameters. The trained model may then be used in runtime operations to compute an embedding vector for an input workload. Doing so allows one or more similar workloads to be identified (e.g., workloads in the training dataset or other workloads having associated embeddings and execution parameters) based on the embedding vectors of the input workload and the similar workloads. The execution parameters of the similar workload(s) may be applied to the input workload to adjust the execution of the first workload, which may improve execution performance of the input workload.

Workloads may not exhibit distinctive attributes and may not correspond to readily recognizable categories for which machine, configuration, and/or software stack optimizations that can be utilized. However, quickly identifying and applying such optimizations may reduce workload execution time and improve workload execution performance. Embodiments disclosed herein may improve the performance of workloads executing on computing systems by programmatically identifying similar workloads and applying the execution parameters of the similar workloads to the target workloads. Doing so may reduce the amount of time and/or resources required to manually optimize a given workload. Further still, the disclosure may be applied to any type of workload. Doing so allows the correct optimizations to be applied to a given workload based on workload similarity. Embodiments are not limited in these contexts.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

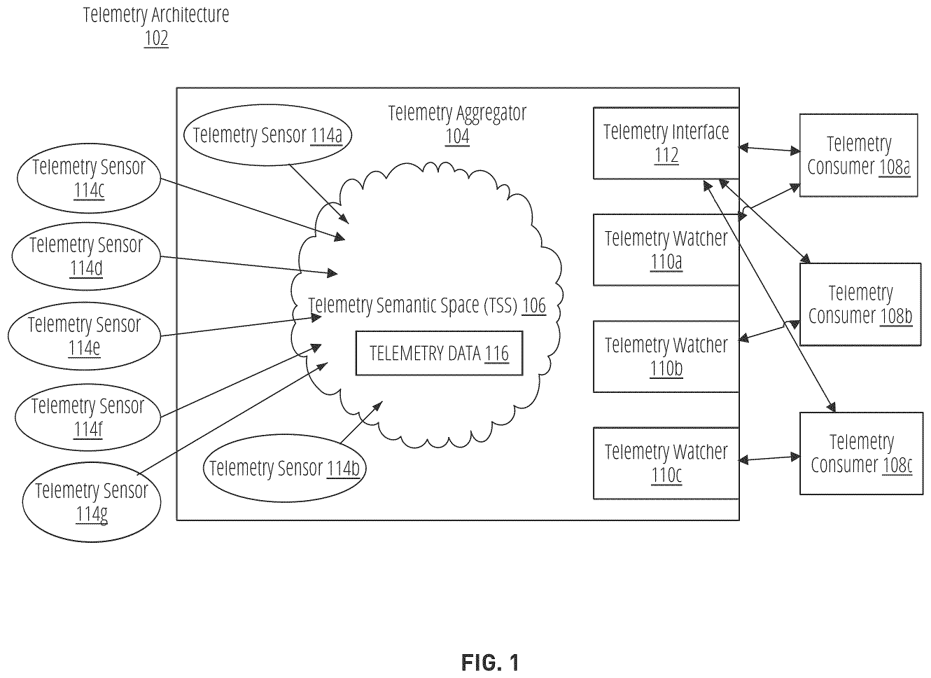

Turning now to FIG. 1, telemetry architecture 102 is depicted. In some examples, telemetry architecture 102 may be implemented on an integrated circuit. The integrated circuit may be included in a processor, a system-on-chip (SoC), single die package, a multi-chip module (MCM), a multi-die package, a chiplet, a dielet, a bridge, an interposer, a discrete package, an add-in card, a chipset, or any other computing hardware.

As depicted, telemetry architecture 102 includes telemetry aggregator 104, telemetry semantic space (TSS) 106, telemetry consumer 108a, telemetry consumer 108b, telemetry consumer 108c, telemetry watcher 110a, telemetry watcher 110b, telemetry watcher 110c, telemetry interface 112, and telemetry sensors 114a-114g.

In general, TSS 106 describes a set of telemetry information, which can be generated and/or exposed by telemetry aggregator 104, for example, from control signals, information elements, or other signals obtained from ones of telemetry sensors 114a-114g. In some examples, the type and form of events and metrics that generate telemetry data 116 and are available in TSS 106 may be dependent on the underlying integrated circuit. The events and metrics may be provided with the underlying integrated circuit in an externally consumable software format for in-band telemetry consumers.

In some embodiments, the sources of telemetry data may include processors, accelerators, network interfaces, communications buses, and/or any other hardware unit. The sources of telemetry data can further include software entities as threads, tasks, modules, utilities, and/or subsystems. Further, the sources of such telemetry streams for a workload or for a chain of microservices can run on multiple hosts in a cluster, and may further span autonomous execution agents like Smart Network Interface Controllers (NICs), smart-storage, database appliances, etc. The telemetry data may be multipoint multiparty telemetry data, e.g., data of various types, from multipoint multiparty event streams (MMES). Examples of telemetry data in MMES include event logs, block traces, performance monitoring counter (PMC) counts, EBS/TBS samples, system software events, application software generated event streams, and/or any other event stream (e.g., from accelerators, NICs, etc.).

The telemetry data 116 may be streamed in a system using various protocols including, but not limited to, such as the transmission control protocol (TCP), the user datagram protocol (UDP), the QUIC protocol, Extensible Markup Language (XML)-Remote Procedure Call (RPC) (XML-RPC) protocols, and/or the gRPC protocol. In some embodiments, the telemetry data 116 may be streamed using cadence-based and/or periodic telemetry, where data sends information to a collector at regularly configured intervals. Cadence-based telemetry may build historical baselines. In some embodiments, known as event-based telemetry, telemetry data 116 sends when a specific event or error occurs, like when a critical link goes down or when the throughput on a link surpasses a specified threshold.

TSS 106 may be implemented as a single memory space or a distributed memory space (e.g., with a contiguous address space, or the like). In some examples, TSS 104 may be implemented as a Static RAM exposed to a memory-mapped input-output space. In some examples, there is a 1:1 (one-to-one) mapping between telemetry aggregator 104 and TSS 106. In some examples, TSS 106 is a flat memory space, which includes all telemetric sensors that telemetry aggregator 102 may use to collect telemetry data 116.

In some embodiments, telemetry sensors 114a-114g may be intellectual property (IP) blocks of the integrated circuit (or SoCs) in which telemetry architecture 102 is implemented. These IP blocks are communicatively coupled to desired sub-circuits to collect telemetry data 116. In general, telemetry sensors 114a-114g are arranged to measure certain physical and/or logical phenomena associated with the sub-circuit being monitored. For example, telemetry sensor 114a could be arranged to monitor temperature (using distributed temperature sensing systems), current voltage (using fully integrated voltage rails), bandwidth (using free running counters), concurrency (using counters), droop (using voltage droop method systems), energy (using energy counters), current (using CPU load current monitor), wear out or aging, (using reliability odometers), electrical margins (using double data rate training), errors (using machine check architecture banks), and time in state (using time-in-state residency), CPU frequency, CPU utilization, cache misses, cache hits, CPU instructions, number of CPU instructions executed per clock cycle (IPC), memory bandwidth (e.g., read bandwidth, write bandwidth, and/or read/write bandwidth), idle wait for thread imbalance, or the like, and store the same as telemetry data 116. Therefore, examples of the telemetry sensors 114a-114g include, but are not limited to, a temperature sensing system, a fully integrated voltage regulator (FIVR) rail, a free running counter, a counter, a voltage droop measuring (VDM) system, a central processing unit (CPU) current load monitor, cache miss counters, cache hit counters, CPU instruction counters, number of CPU instructions executed per clock cycle (IPC) counters, memory bandwidth counters, a performance counter monitor (PCM), an energy counter, a reliability odometer, a machine check architecture (MCA) bank, or a time-in-state residency. It is to be appreciated, that each of telemetry sensors 114b to 114g may be arranged to monitor different physical and/or logical phenomena than that which telemetry sensor 114a is arranged.

Telemetry sensors 114a-114g may share or report the collected telemetry data 116 to telemetry aggregator 104. Telemetry aggregator 104 may store the reported telemetry data 116 in TSS 106. With some examples, ones of telemetry sensors 114a-114g report or share the telemetric data through a wireless communication protocol (e.g., Wi-Fi, Bluetooth, Bluetooth Low energy, Near Field Communication (NFC), ZigBee, or the like). In some examples, ones of telemetry sensors 114a-114g may report or share data through a shared data bus, wired communication, or other data communication technology.

With some examples, telemetry interface 112 may provide telemetry consumers 108a to 108c access to telemetry aggregator 104 to retrieve telemetric data stored in TSS 106. For example, access of telemetry interface 112 by a telemetry consumer 108a-108c may require telemetry-specific commands to be sent and decoded on a communication bus of the integrated circuit. The telemetry consumer 108a-108c may be an in-band telemetry consumer or an out-of-band telemetry consumer. Examples are not limited in this context.

Telemetry commands may be mapped onto the existing protocol of the communication bus. As used herein, “telemetry commands” are commands issued by software, firmware, or other sources to discover, access, and configure telemetry data 116. Examples of telemetry commands may include commands to initiate discovery of the types of telemetry supported by a telemetry aggregator 102, write data to configuration registers of a telemetry watcher 110a to 110c, read the state of a configuration register of a telemetry watcher 110a to 110c, and read the telemetry data 116 stored in TSS 106.

The telemetry watchers 110a-110c allow a telemetry consumer 108a-108c to instruct telemetry aggregator 104 to watch one or more telemetry items (e.g., one or more of the telemetry sensors 114a-114g) along with an associated frequency, any thresholds, and/or alerts to be generated. The telemetry watchers 110a-110c may include Interrupt Configuration Registers, Global Time Stamp Counters, a sampling frequency counter for the selected telemetry sensors 114a-114g, an action counter to trigger an interrupt on any threshold crossings, and a watcher instance ID. Instances of the telemetry watchers 110a-110c are available to consumers via in-band or out-of-band mechanisms. For example, for servers, the interface can be handled via management component transport protocol (MCTP) and Platform Environment Control Interface (PECI)-based API requests. For host agents, the telemetry watchers 110a-110c may provide an memory-mapped I/O (MMIO) interface (I/F) that translates primary memory and configuration requests to the sideband. In some embodiments, all telemetry watchers 110a-110c are derived from a common base which defines the basic set of configuration and status registers needed to interface with the telemetry watchers 110a-110c. Additional functionality may be provided through extensions to the base or filtering mechanisms attached to the telemetry watchers 110a-110c.

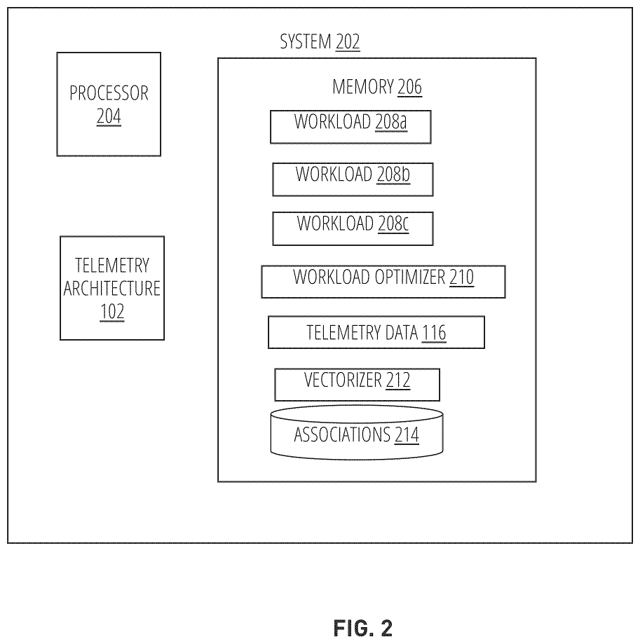

FIG. 2 illustrates an example system 202 to optimize workloads based on workload similarity. The system 202 includes the components of the telemetry architecture 102. The system 202 further comprises at least a processor 204 and a memory 206. Although one instance of system 202 is depicted in FIG. 2, multiple instances of the system 202 may be used, e.g., to execute workloads on each instance of the system 202. Embodiments are not limited in these contexts.

The system 202 is representative of any type of computing system. For example, the system 202 may be a server, a system-on-chip (SoC), a cloud computing node, a compute cluster, an Infrastructure Processing Unit (IPU), a data processing unit (DPU), a computer, a virtualized system, or any other type of computing system. In some embodiments, the system 202 is included in a data center and/or cloud computing environment provided by a cloud service provider. Example cloud service providers include, but are not limited to, Google® Cloud, Microsoft® Azure®, and Amazon® Web Services (AWS), Baidu® Cloud, Bytedance® Cloud, BytePlus®, and Tencent® Cloud.

Hardware of the computing system 202 (and/or another instance of the computing system 202) may be used to execute one or more workloads. As shown, the workloads include a workload 208a, a workload 208b, and a workload 208c. However, any number of workloads may be executed, such as thousands of workloads. The workloads 208a-208c are representative of any type of executable code. For example, the workloads 208a-208c may be a process, a thread, a virtual machine, a container, a microservice, an application, etc. Examples of workloads include database workloads, artificial intelligence (AI) workloads, storage workloads, inference workloads, mathematical workloads, and the like. Embodiments are not limited in these contexts.

Often, the execution performance of a workload, such as workload 208a, may need improvement. However, configuring workload 208a and/or the components of the system 202 to improve the execution performance of the workload 208a requires extensive time and/or resources, e.g., to analyze the overall configuration of the workload 208a and/or system 202. However, embodiments disclosed herein may identify workloads that are similar to workload 208a to adjust the execution parameters of the workload 208a, thereby improving the execution performance of workload 208a. For example, workload 208a may be a first type of Java® application while workload 208b may be associated with a second type of Java application that has been optimized according to a set of execution parameters stored in the associations 214. In some embodiments, the first and second types of Java applications may be similar, which may permit the application of the execution parameters of the second type of Java application to the first type of Java application. Embodiments are not limited in these contexts.

As shown, the system 202 includes a workload optimizer 210, a vectorizer 212, and a data store of associations 214. The associations 214 may store associations between a workload and a set of execution parameters. For example, associations 214 may store a respective embedding for a plurality of workloads and a respective set of execution parameters for each embedding (where the set of execution parameters is associated with one or more optimizations to improve performance of the associated workload). The workload optimizer 210 is configured to adjust the execution parameters of an input workload based on the execution parameters of workloads that are similar to the input workload. Adjusting the execution parameters may include changing a subset of available execution parameters and/or changing values associated with execution parameters. The execution parameters may include any number and type of resource, such as hardware resources, software resources, or a combination thereof. Examples of execution parameters allocated to a workload may include, but are not limited to, a number of processors, processor frequencies, cache capacities, memory bandwidths, numbers of hardware threads, numbers of processor cores, using hyperthreading, using different memory technologies (e.g., compute express link (CXL) memory pools, distributed memories, etc.), allocating peripheral device resources (e.g., accelerators, storage, graphics processors, vision processors, etc.), caching algorithms, prefetching algorithms, software stack parameters, bios parameters, OS parameters, memory page size parameters, support libraries used by an application (e.g., if an application is using OpenMP® as a threading library—a number of OpenMP threads), an application itself (e.g., if the application is a browser, then whether to use a GPU for rendering), whether to enable cache for improving performance, etc. More generally, the execution parameters include any operating parameter that may adjust the execution performance of a workload.

As stated, the adjusting of execution parameters may include allocating hardware resources. More generally, hardware resources may be allocated to execute instances of workloads 208a-208c at any time. In some embodiments, the allocation of resources may include allocating virtualized instances of hardware resources, e.g., to multiple software entities such as VMs or containers. Doing so causes a hardware device to appear as multiple separate devices to software. A virtualized instance of a hardware resource may include a subset of the actual hardware resources. For example, if a GPU is to be allocated to the execution of a workload, a virtualized instance of the GPU may be created and allocated to a workload, container, and/or VM. In some embodiments, the virtualized hardware instance created using scalable I/O virtualization (S-IOV). However, any hardware virtualization technique may be used.

The vectorizer 212 is a model trained to compute one or more vectors for an input workload, such as workloads 208a-208c. The vectorizer 212 may be implemented in any format, such as a neural network, machine learning (ML) model, or a rules-based system. In some embodiments, the vectorizer 212 may execute on an accelerator device such as a neural network accelerator, a GPU, a general purpose GPU (GPGPU), or a matrix math accelerator. Embodiments are not limited in these contexts. For example, training data may be used to train the vectorizer 212. The training data may include multi-dimensional workload profiles of a plurality of training workloads. For example, a plurality of training workloads may be executed on a training system such as system 202. In some embodiments, the execution of the training workloads is in a controlled test environment. The execution of the training workloads generates telemetry data 116. The execution parameters (and/or values of the execution parameters) of the training workloads may be varied over time, e.g., based on available optimizations to the training workload and/or the computing system 202 used to execute the training workloads. Therefore, as the telemetry data 116 is collected, the telemetry data 116 may be associated with different execution parameters of the training workloads.

For example, during a first time interval, a first set of execution parameters for a first training workload may include a first number of processor cores, a first number of threads, a first cache size, etc. Similarly, during a second time interval, a second set of execution parameters may include a second number of processor cores, a second number of threads, a second cache size, etc. Therefore, the telemetry data 116 generated during the first time interval may reflect the performance in executing the first workload using the first set of execution parameters, while the telemetry data 116 generated during the second time interval may reflect the performance in executing the first workload using the second set of execution parameters. Stated differently, the workload profiles included in the training data may include a two-dimensional telemetry matrix of size “n×m” for a workload, where “n” corresponds to one or more counters in the telemetry data 116 and “m” corresponds to a set of execution parameters (and/or any associated values of the execution parameters) for the workload. In some embodiments, the set of execution parameters may act as stimuli and extract sufficient correlation among several different observable telemetry variables, which would be typically scattered among different levels of hardware-software stack and across different resource stressors that may be unevenly distributed among different threads, processes, etc. Examples of such execution parameters may include, but are not limited to, a number of processors, processor frequencies, cache capacities, memory bandwidths, numbers of hardware threads, numbers of processor cores, using different memory technologies (e.g., compute express link (CXL) memory pools, distributed memories, etc.), caching algorithms, prefetching algorithms, etc.

Over time, the vectorizer 212 may be trained to generate vectors for one or more workloads based on the telemetry matrix of a workload such that the vectors of similar workloads are near each other in the vector space of the vectors. In some embodiments, the vectors are embeddings (also referred to as embedding vectors) in a vector space. For example, as workload 208a executes, the telemetry matrix for the workload 208a may be gathered. The vectorizer 212 may then compute an embedding for workload 208a based on the telemetry matrix for workload 208a. A workload such as workload 208b may be identified as being most similar to workload 208a based on the embedding of workload 208a and an embedding for workload 208b. In some embodiments, the embedding for workload 208b is stored in the associations 214. In some embodiments, the vectorizer 212 computes the embedding for workload 208b.

The similarity between two workloads may be based on any suitable metric. In some embodiments, the similarity is based on a Euclidean distance between two embeddings. In some embodiments, the similarity is based on a cosine distance of an angle formed by two embeddings. In some embodiments, the similarity is based on approximate nearest neighbor search, which may identify the embedding most similar to another embedding. Embodiments are not limited in these contexts.

For example, using the Euclidean distance technique, the distance between embeddings for workload 208a and workload 208b may be less than the distance between embeddings for workload 208a and workload 208c. Therefore, the workload optimizer 210 may determine the workload 208b is most similar to workload 208a. The workload optimizer 210 may identify the execution parameters associated with workload 208b in the associations 214 (e.g., based on the embedding for workload 208b). The workload optimizer 210 may then apply the execution parameters associated with workload 208b to workload 208a. For example, doing so may allocate additional processor threads, processor cores, processor frequency to the workload 208a, which may improve the performance of workload 208a without having to manually optimize workload 208a. In some embodiments, two or more workloads (e.g., workload 208b and workload 208c) may be identified as similar to an input workload such as workload 208a. In such embodiments, the execution parameters for each identified workload may be applied to the input workload. In some embodiments, the embedding for workload 208a may be associated with the execution parameters of workload 208b in the associations 214 after the execution parameters of workload 208b are applied to workload 208a. In some embodiments, the execution of workload 208a is monitored based on telemetry data 116 to determine that the performance of workload 208a improves prior to adding the association to the associations 214. Embodiments are not limited in these contexts.

In some embodiments, an on-premises hybrid solution may be provided. For example, the system 202 may include cloud service provider infrastructure and services. One example of an on-premises hybrid solution is AWS Outposts. In such embodiments, workloads 208a-208c may execute on one or more instances of the system 202. In some such embodiments, the system 202 may leverage the services and/or infrastructure of the CSP, e.g., to improve the performance in executing the workloads 208a-208c For example, the on-premises systems 202 may be extended to include the infrastructure and/or resources of the CSP to meet the demand of workloads 208a-208c. For example, hardware resources of the CSP may be provisioned to execute at least a portion of the workloads 208a-208c, thereby improving performance of the workloads 208a-208c via a hybrid cloud environment.

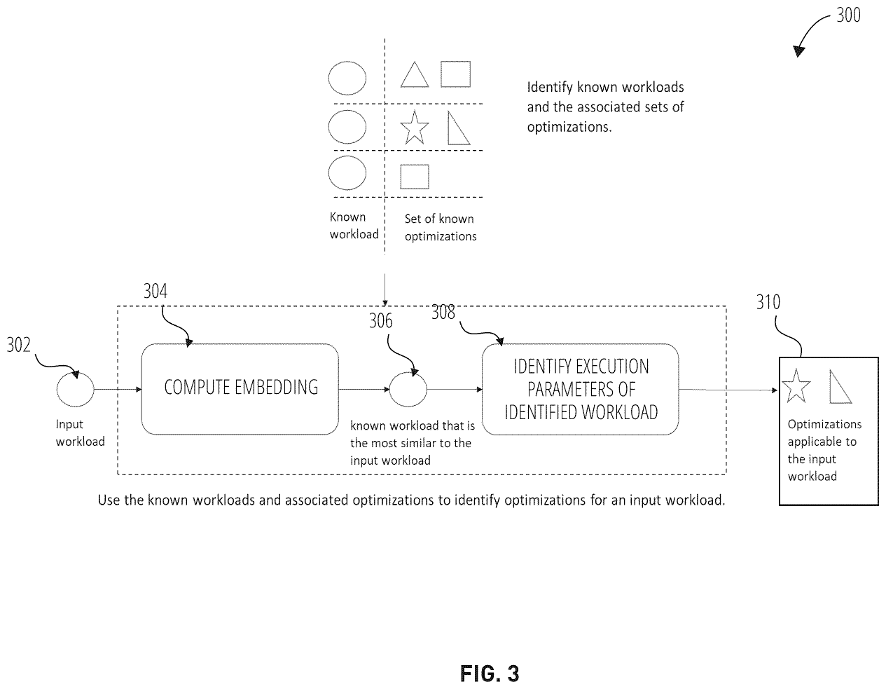

FIG. 3 is a schematic 300 illustrating an example of adjusting workload execution based on workload similarity. As shown, at block 302, an input workload such as workload 208a may execute on one or more systems. As the workload 208a executes, telemetry data 116 may be collected for the workload 208a. The workload optimizer 210 or any other suitable component may generate a telemetry matrix for the workload 208a based on the collected telemetry data 116. At block 304, the vectorizer 212 may compute an embedding vector for workload 208a based on the telemetry matrix of workload 208a. The embedding vector may be used to identify a workload such as workload 208b that is most similar to the workload 208a, e.g., based on the embedding vector of workload 208a and the embedding vector of workload 208b. At block 308, the workload optimizer 210 may identify, in the associations 214, a set of execution parameters for the workload 208b. At block 310, the workload optimizer 210 may cause the set of execution parameters to be applied to the execution of workload 208a. Embodiments are not limited in these contexts.

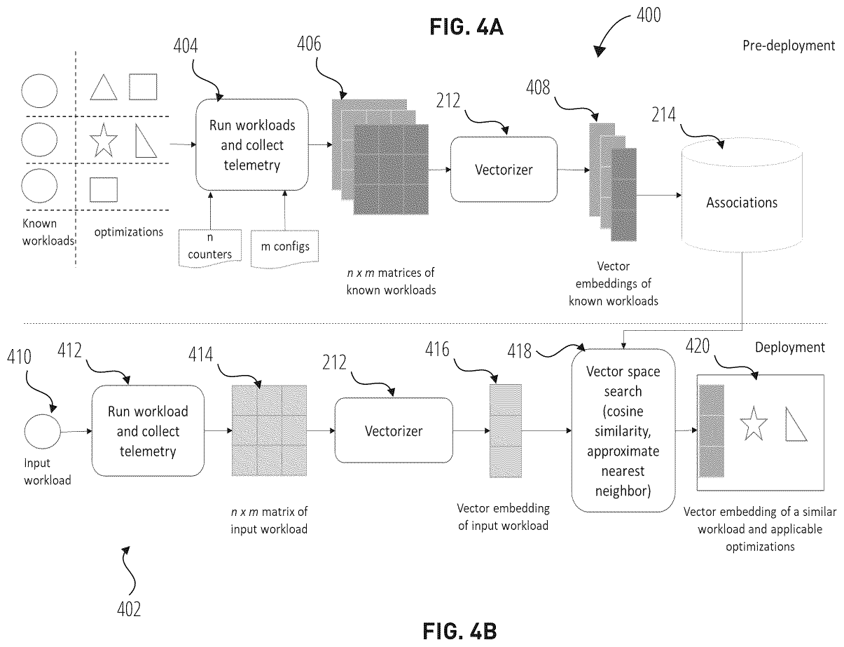

FIG. 4A illustrates a training phase 400 of the vectorizer 212, according to an embodiment. As shown, at block 404, a plurality of training workloads may be executed and telemetry data 116 may be collected for each training workload. The plurality of training workloads may include different sets of telemetry counters (e.g., different subsets of telemetry data 116) for a given training workload and/or different execution parameters for the workload (e.g., different hardware and/or software configurations determined to improve the execution performance of the associated workload). Doing so may generate the n×m training matrices 406 for each training workload.

The vectorizer 212 may then be trained based on the matrices 406 to generate one or more embeddings 408 for each matrix 406. An embedding 408 and an optimized set of execution parameters may be stored in the associations 214 for each training workload. The optimized set of execution parameters may be manually determined and/or determined by the vectorizer 212 during training (e.g., by identifying which set of execution parameters resulted in telemetry data 116 that reflects improved performance). Embodiments are not limited in these contexts.

In some embodiments, the vectorizer 212 is trained using a sample supervised learning task such as workload classification (workload classification is a task of classifying workloads into different classes, given their execution profiles obtained using hardware/software counters). In some embodiments, the training of the vectorizer 212 provides techniques to determine workload similarity without requiring a specific domain-level similarity. Stated differently, the training of the vectorizer 212 may facilitate cross-domain optimizations for workloads. Embodiments are not limited in these contexts.

FIG. 4B illustrates a deployment phase 402 (also referred to as a “runtime phase” or an “inference phase”). As shown, an input workload 410 may be executed at block 412. The input workload 410 may be the same as one or more of workloads 208a-208c. In some embodiments, the input workload 410 is executed in a controlled test environment. Doing so may cause telemetry data 116 to be generated for the input workload 410. The workload optimizer 210 may generate a telemetry matrix 414 for the input workload based on the collected telemetry data 116 and the execution parameters for the input workload 410. The vectorizer 212 may compute embeddings 408 for the input workload 410 at block 416. At block 418, a workload similar to the input workload 410 is identified, e.g., based on the embedding for the input workload 410 computed at block 416 and the embeddings 408 of the training workloads. Once a similar workload is identified, the embedding of the similar workload is used to identify the set of execution parameters associated with the embedding of the similar workload in the associations 214. At block 420, the execution parameters of the similar workload identified in the associations 214 are used to adjust the execution of the input workload 410. For example, additional resources may be allocated to the execution of the input workload 410. The resources may include any type of hardware and/or software resource, such as threads, cores, cache, interfaces, etc. Embodiments are not limited in these contexts.

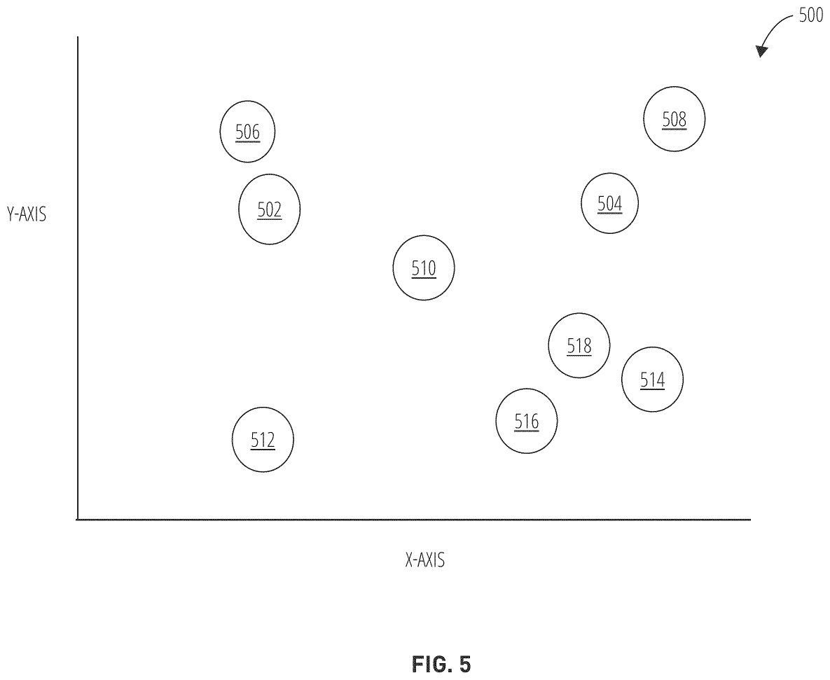

FIG. 5 illustrates an example graph 500 of embeddings 502-518 generated by the vectorizer 212. The embeddings 502-518 are in an n-dimensional embedding space, where n is any positive integer greater than 1. Therefore, the embeddings 502-518 may include n values, e.g., a respective value for each dimension in the embedding space. However, due to the limitations of computer displays, an x-axis and a y-axis are depicted in the graph 500. The x-axis may correspond to a first component for principal component analysis (PCA) and the y-axis may correspond to a second PCA component. In some embodiments, the values in the embeddings 502-518 are floating point values. More generally, by reducing the dimensionality of data, the embeddings may act as a “fingerprint” that facilitates comparisons between different workloads. Embodiments are not limited in these contexts.

The embeddings 502-518 are representative of the embeddings 408. The embeddings 502-518 may encode any type of information. In some embodiments, some execution parameters may be specific to a type of hardware and/or a type of architecture. As such, the embeddings 502-518 may concatenate the hardware-specific and/or architecture-specific details, thereby allowing the vectorizer 212 to compare both the performance counters in the telemetry data 116 and hardware and/or architecture these measurements were collected on. In some embodiments, execution parameters may be specific to an artifact of a workload, such as tuning a specific input parameter of the workload (e.g., a value of a variable, etc.). In such embodiments, these optimizations may not be directly applicable to other workloads. Therefore, in such embodiments, additional input is applied to model these parameters. In some embodiments, workloads may have equivalent execution parameters that vary in name (e.g., “make −jN” and “OMP_NUM_THREADS=N” both specify the number of concurrent workers, albeit make uses processes and OMP uses threads). In such embodiments, the vectorizer 212 and/or associations 214 may store a table of equivalence mappings between variable names. In some embodiments, the embeddings 502-518 may further encode the presence and/or absence of specialized instruction set architecture (ISA) extensions, the density of indirect branches and indirect calls in core code paths (which can be obtained by collecting flame-graphs and then running static analysis in blocks that are responsible for high processor utilization). Embodiments are not limited in these contexts.

As stated, the vectorizer 212 may compute an embedding for an input workload, e.g., workload 208a, which may be represented as embedding 502 in the graph 500. The workload optimizer 210 may compare the embedding 502 to other embeddings in the embedding space, e.g., embeddings 504-518. The embeddings 504-518 may be associated with one or more other workloads, such as workload 208b or workload 208c. The workload optimizer 210 may select an embedding from the embedding space that is most similar to the embedding 502 computed for the input workload.

In some embodiments, the similarity between embeddings is based on a respective distance between each of the embeddings 504-518 to the embedding 502 in the embedding space. In such an example, the embedding having the lowest distance to the computed embedding 502 is selected. Example distances include Euclidean distances or cosine similarity (e.g., the cosine similarity of an angle formed by two embedding vectors).

For example, using a Euclidean distance for the embodiment depicted in FIG. 5, the embedding 506 may be the most similar to the computed embedding 502, as the embedding 502 is nearest to embedding 506. Stated differently, the Euclidean distance between embedding 502 and embedding 506 may be the least distance relative to the Euclidean distance between embeddings 502 and 504 and the Euclidean distance between embeddings 502 and 508. The embedding 506 may be associated with a workload such as workload 208b. The workload optimizer 210 may then select a set of execution parameters associated with the workload 208b in the associations 214 and apply the execution parameters to the workload 208a. Embodiments are not limited in these contexts.

In some embodiments, locality-sensitive hashing (LSH) may be used to create clusters of workloads. For example, the vectorizer 212 may use LSH to cluster an input workload. The LSH may be tuned to elect a form of LSH that is locality preserving. A locality-preserving hash may be a hash function ƒ that maps points in a metric space M=(M, d) to a scalar value such that d(p, q)<d(q, r)⇒|ƒ(p)−ƒ(q)|<|ƒ(a)−ƒ(r)| for any three points p, q, r∈M and d is the distance metric. A neural network may be used to tune the formulation of the distance metric. In general, a workload to be optimized may be identified as “similar” according to LSH above, to more than one workload having an associated vector and set of execution parameters in the associations 214. In such cases, execution parameters may be chosen from more than one known workload and blended (using weighting where weighting is possible, or some other aggregation method such as consensus, majority, etc.). Embodiments are not limited in these contexts.

In some embodiments, the workload optimizer 210 may be deployed as a software as a service (SaaS) model, where given an input workload and telemetry information (e.g., telemetry matrix), the workload optimizer 210 returns a set of applicable optimizations via one or more execution parameters for one or more workloads in the associations 214.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

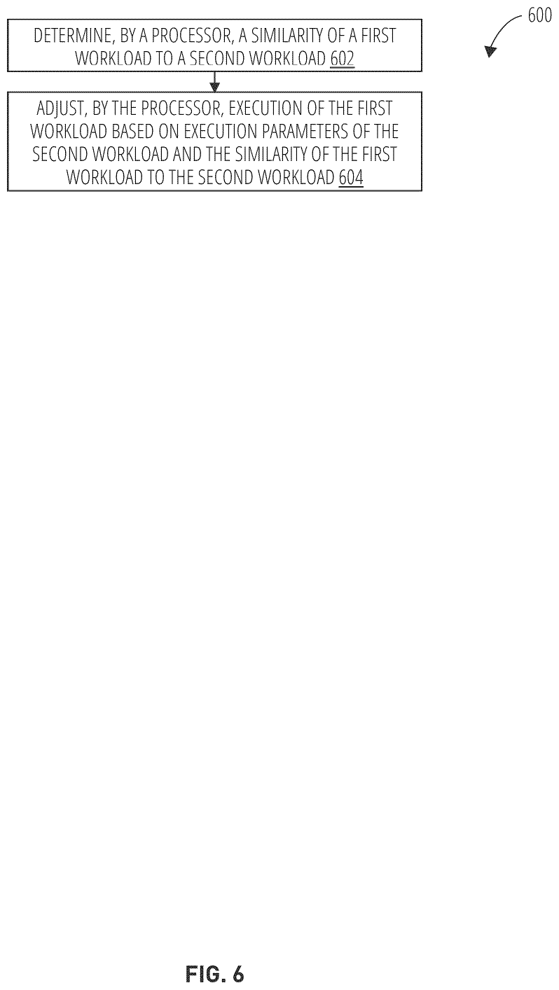

FIG. 6 illustrates an embodiment of a logic flow 600. The logic flow 600 may be representative of some or all of the operations executed by one or more embodiments described herein. For example, the logic flow 600 may include some or all of the operations to adjust workload execution based on workload similarity. Embodiments are not limited in this context.

In block 602, logic flow 600 determines, by a processor, a similarity of a first workload to a second workload. For example, the workload optimizer 210 may determine that a first workload 208a is most similar to a second workload 208b. The similarity may be based on embeddings for each workload 208a, 208b. In some embodiments, the similarity is based on one or more of a Euclidean distance between the embeddings, a cosine similarity of an angle between the embeddings, a nearest neighbor to the embedding for workload 208a, etc.

In block 604, logic flow 600 adjusts, by the processor, execution of the first workload based on execution parameters of the second workload and the similarity of the first workload to the second workload. For example, the associations 214 may store a set of execution parameters for workload 208b. The workload optimizer 210 may identify the execution parameters for workload 208b in associations 214 and cause the execution parameters for workload 208b to be applied to the execution of workload 208a. For example, additional hardware and/or software resources may be allocated to workload 208a. Example resources include processors, processor cores, memories, caches, network interfaces, memory interfaces, bandwidths, I/O devices, I/O bandwidth, cache prefetching algorithms, caching algorithms, etc.

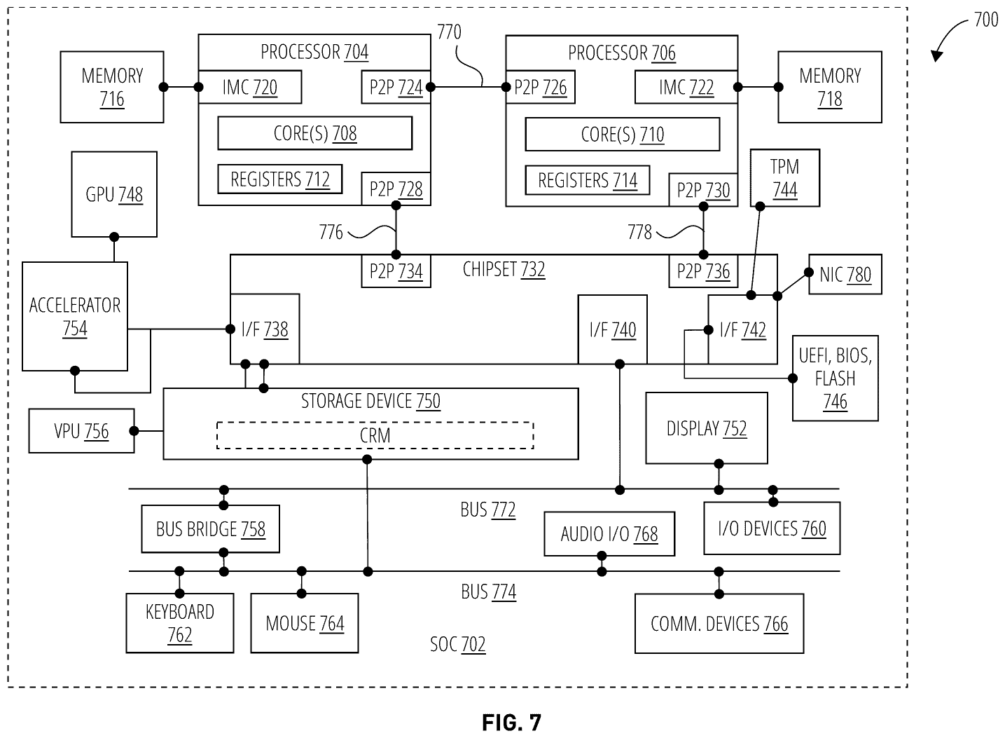

FIG. 7 illustrates an embodiment of a system 700. System 700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), an Infrastructure Processing Unit (IPU), a data processing unit (DPU), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. Examples of IPUs include the AMD® Pensando IPU. Examples of DPUs include the Fungible DPU, the Marvell® OCTEON and ARMADA DPUs, the NVIDIA BlueField® DPU, the ARM® Neoverse N2 DPU, and the AMD® Pensando DPU. In other embodiments, the system 700 may have a single processor with one core or more than one processor. Note that the term “processor” refers to a processor with a single core or a processor package with multiple processor cores. In at least one embodiment, the computing system 700 is representative of some or all of the components of the telemetry architecture 102 and/or system 202. More generally, the computing system 700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary system 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 7, system 700 comprises a system-on-chip (SoC) 702 for mounting platform components. System-on-chip (SoC) 702 is a point-to-point (P2P) interconnect platform that includes a first processor 704 and a second processor 706 coupled via a point-to-point interconnect 770 such as an Ultra Path Interconnect (UPI). In other embodiments, the system 700 may be of another bus architecture, such as a multi-drop bus. Furthermore, each of processor 704 and processor 706 may be processor packages with multiple processor cores including core(s) 708 and core(s) 710, respectively. While the system 700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 704 and chipset 732. Some platforms may include additional components and some platforms may only include sockets to mount the processors and/or the chipset. Furthermore, some platforms may not have sockets (e.g. SoC, or the like). Although depicted as a SoC 702, one or more of the components of the SoC 702 may also be included in a single die package, a multi-chip module (MCM), a multi-die package, a chiplet, a bridge, and/or an interposer. Therefore, embodiments are not limited to a SoC.

The processor 704 and processor 706 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 704 and/or processor 706. Additionally, the processor 704 need not be identical to processor 706.

Processor 704 includes an integrated memory controller (IMC) 720 and point-to-point (P2P) interface 724 and P2P interface 728. Similarly, the processor 706 includes an IMC 722 as well as P2P interface 726 and P2P interface 730. IMC 720 and IMC 722 couple the processor 704 and processor 706, respectively, to respective memories (e.g., memory 716 and memory 718). Memory 716 and memory 718 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 716 and the memory 718 locally attach to the respective processors (e.g., processor 704 and processor 706). In other embodiments, the main memory may couple with the processors via a bus and shared memory hub. Processor 704 includes registers 712 and processor 706 includes registers 714.

System 700 includes chipset 732 coupled to processor 704 and processor 706. Furthermore, chipset 732 can be coupled to storage device 750, for example, via an interface (I/F) 738. The I/F 738 may be, for example, a Peripheral Component Interconnect Express (PCIe) interface, a Compute Express Link® (CXL) interface, or a Universal Chiplet Interconnect Express (UCIe) interface. Storage device 750 can store instructions executable by circuitry of system 700 (e.g., processor 704, processor 706, GPU 748, accelerator 754, vision processing unit 756, or the like). For example, storage device 750 can store instructions for the workload optimizer 210, vectorizer 212, workloads 208a-208c, input workload 410, or the like.

Processor 704 couples to the chipset 732 via P2P interface 728 and P2P 734 while processor 706 couples to the chipset 732 via P2P interface 730 and P2P 736. Direct media interface (DMI) 776 and DMI 778 may couple the P2P interface 728 and the P2P 734 and the P2P interface 730 and P2P 736, respectively. DMI 776 and DMI 778 may be a high-speed interconnect that facilitates, e.g., eight Giga Transfers per second (GT/s) such as DMI 3.0. In other embodiments, the processor 704 and processor 706 may interconnect via a bus.

The chipset 732 may comprise a controller hub such as a platform controller hub (PCH). The chipset 732 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 732 may comprise more than one controller hub such as a chipset with a memory controller hub, a graphics controller hub, and an input/output (I/O) controller hub.

In the depicted example, chipset 732 couples with a trusted platform module (TPM) 744 and UEFI, BIOS, FLASH circuitry 746 via I/F 742. The TPM 744 is a dedicated microcontroller designed to secure hardware by integrating cryptographic keys into devices. The UEFI, BIOS, FLASH circuitry 746 may provide pre-boot code.

Furthermore, chipset 732 includes the I/F 738 to couple chipset 732 with a high-performance graphics engine, such as, graphics processing circuitry or a graphics processing unit (GPU) 748. In some embodiments, the GPU 748 is a general purpose GPU (GPGPU). In other embodiments, the system 700 may include a flexible display interface (FDI) (not shown) between the processor 704 and/or the processor 706 and the chipset 732. The FDI interconnects a graphics processor core in one or more of processor 704 and/or processor 706 with the chipset 732.

The system 700 is operable to communicate with wired and wireless devices or entities via the network interface controller (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE, 5G, 6G wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 754 and/or vision processing unit 756 can be coupled to chipset 732 via I/F 738. The accelerator 754 is representative of any type of accelerator device (e.g., a data streaming accelerator, cryptographic accelerator, cryptographic co-processor, neural network accelerator, matrix math accelerator, GPGPU, an offload engine, etc.). Examples of an accelerator 754 include the AMD Instinct® or Radeon® accelerators, the NVIDIA® HGX and SCX accelerators, and the ARM Ethos-U NPU.

The accelerator 754 may be a device including circuitry to accelerate copy operations, data encryption, hash value computation, data comparison operations (including comparison of data in memory 716 and/or memory 718), and/or data compression. For example, the accelerator 754 may be a USB device, PCI device, PCIe device, CXL device, UCIe device, and/or an SPI device. The accelerator 754 can also include circuitry arranged to execute machine learning (ML) related operations (e.g., training, inference, etc.) for ML models. Generally, the accelerator 754 may be specially designed to perform computationally intensive operations, such as hash value computations, comparison operations, cryptographic operations, and/or compression operations, in a manner that is more efficient than when performed by the processor 704 or processor 706. Because the load of the system 700 may include hash value computations, comparison operations, cryptographic operations, and/or compression operations, the accelerator 754 can greatly increase performance of the system 700 for these operations.

The accelerator 754 may be embodied as any type of device, such as a coprocessor, application-specific integrated circuit (ASIC), field-programmable gate array (FPGA), functional block, IP core, graphics processing unit (GPU), a processor with specific instruction sets for accelerating one or more operations, or other hardware accelerator capable of performing the functions described herein. In some embodiments, the accelerator 754 may be packaged in a discrete package, an add-in card, a chipset, a multi-chip module (e.g., a chiplet, a dielet, etc.), and/or an SoC. Embodiments are not limited in these contexts.

The accelerator 754 may include one or more dedicated work queues and one or more shared work queues (each not pictured). Generally, a shared work queue is configured to store descriptors submitted by multiple software entities. The software may be any type of executable code, such as a process, a thread, an application, a virtual machine, a container, a microservice, etc., that share the accelerator 754. For example, the accelerator 754 may be shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 754 via a non-posted write (e.g., a deferred memory write (DMWr)). One example of an instruction that atomically submits a work descriptor to the shared work queue of the accelerator 754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 754. The dedicated work queue may accept job submissions via commands such as the movdir64b instruction.

Various I/O devices 760 and display 752 couple to the bus 772, along with a bus bridge 758 which couples the bus 772 to a second bus 774 and an I/F 740 that connects the bus 772 with the chipset 732. In one embodiment, the second bus 774 may be a low pin count (LPC) bus. Various devices may couple to the second bus 774 including, for example, a keyboard 762, a mouse 764 and communication devices 766.

Furthermore, an audio I/O 768 may couple to second bus 774. Many of the I/O devices 760 and communication devices 766 may reside on the system-on-chip (SoC) 702 while the keyboard 762 and the mouse 764 may be add-on peripherals. In other embodiments, some or all the I/O devices 760 and communication devices 766 are add-on peripherals and do not reside on the system-on-chip (SoC) 702.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to the Figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments, from which numerous permutations and configurations will be apparent.

Example 1 includes a method, comprising: determining, by a processor, a similarity of a first workload to a second workload; and adjusting, by the processor, execution of the first workload based on execution parameters of the second workload and the similarity of the first workload to the second workload.

Example 2 includes the subject matter of example 1, wherein the first workload is represented as a first vector and the second workload is represented as a second vector.

Example 3 includes the subject matter of example 2, wherein the similarity is based on the first and second vectors.

Example 4 includes the subject matter of example 2, wherein the similarity is based on at least one of a distance between the first and second vectors in a vector space or a cosine similarity between the first and second vectors.

Example 5 includes the subject matter of example 2, further comprising: computing, by a neural network, the first vector based on telemetry data associated with the execution of the first workload and execution parameters of the first workload.

Example 6 includes the subject matter of example 5, wherein the first vector comprises an embedding vector.

Example 7 includes the subject matter of example 1, wherein adjusting the execution of the first workload comprises allocating additional computing resources to the first workload based on an amount of resources allocated to the second workload, wherein the execution parameters of the second workload indicate the amount of resources allocated to the second workload.

Example 8 includes a non-transitory computer-readable storage medium, the computer-readable storage medium including instructions that when executed by a computer, cause the computer to: determine a similarity of a first workload to a second workload; and adjust execution of the first workload based on execution parameters of the second workload.

Example 9 includes the subject matter of example 8, wherein the first workload is represented as a first vector and the second workload is represented as a second vector.

Example 10 includes the subject matter of example 9, wherein the similarity is based on the first and second vectors.

Example 11 includes the subject matter of example 9, wherein the similarity is based on at least one of a distance between the first and second vectors in a vector space or a cosine similarity between the first and second vectors.

Example 12 includes the subject matter of example 9, wherein the instructions further configure the computer to: compute, by a neural network, the first vector based on telemetry data associated with the execution of the first workload and execution parameters of the first workload.

Example 13 includes the subject matter of example 12, wherein the first vector comprises an embedding vector.

Example 14 includes the subject matter of example 8, wherein adjusting the execution of the first workload comprises allocate additional computing resources to the first workload based on an amount of resources allocated to the second workload, wherein the execution parameters of the second workload indicate the amount of resources allocated to the second workload.

Example 15 includes a computing apparatus comprising: a processor; and a memory storing instructions that, when executed by the processor, cause the processor to: determine a similarity of a first workload to a second workload; and adjust execution of the first workload based on execution parameters of the second workload.

Example 16. The computing apparatus of claim 15, wherein the first workload is represented as a first vector and the second workload is represented as a second vector.

Example 17. The computing apparatus of claim 16, wherein the similarity is based on the first and second vectors.

Example 18. The computing apparatus of claim 16, wherein the similarity is based on at least one of a distance between the first and second vectors in a vector space or a cosine similarity between the first and second vectors.

Example 19. The computing apparatus of claim 16, wherein the instructions further cause the processor to: compute, by a neural network, the first vector based on telemetry data associated with the execution of the first workload and execution parameters of the first workload.

Example 20. The computing apparatus of claim 19, wherein the first vector comprises an embedding vector.

Example 21. The computing apparatus of claim 15, wherein adjusting the execution of the first workload comprises allocating additional computing resources to the first workload based on an amount of resources allocated to the second workload, wherein the execution parameters of the second workload indicate the amount of resources allocated to the second workload.

Example 22 includes an apparatus, comprising: means for determining a similarity of a first workload to a second workload; and means for adjusting execution of the first workload based on execution parameters of the second workload and the similarity of the first workload to the second workload.

Example 23 includes the subject matter of example 22, wherein the first workload is represented as a first vector and the second workload is represented as a second vector.

Example 24 includes the subject matter of example 23, wherein the similarity is based on the first and second vectors.

Example 25 includes the subject matter of example 23, wherein the similarity is based on at least one of a distance between the first and second vectors in a vector space or a cosine similarity between the first and second vectors.

Example 26 includes the subject matter of example 23, further comprising: means for computing the first vector based on telemetry data associated with the execution of the first workload and execution parameters of the first workload.

Example 27 includes the subject matter of example 26, wherein the first vector comprises an embedding vector.

Example 28 includes the subject matter of example 22, wherein adjusting the execution of the first workload comprises allocating additional computing resources to the first workload based on an amount of resources allocated to the second workload, wherein the execution parameters of the second workload indicate the amount of resources allocated to the second workload.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method, comprising:
determining, by a processor, a similarity of a first workload to a second workload; and
adjusting, by the processor, execution of the first workload based on execution parameters of the second workload and the similarity of the first workload to the second workload.

2. The method of claim 1, wherein the first workload is represented as a first vector and the second workload is represented as a second vector.

3. The method of claim 2, wherein the similarity is based on the first and second vectors.

4. The method of claim 2, wherein the similarity is based on at least one of a distance between the first and second vectors in a vector space or a cosine similarity between the first and second vectors.

5. The method of claim 2, further comprising:
computing, by a neural network, the first vector based on telemetry data associated with the execution of the first workload and execution parameters of the first workload.

6. The method of claim 5, wherein the first vector comprises an embedding vector.

7. The method of claim 1, wherein adjusting the execution of the first workload comprises allocating additional computing resources to the first workload based on an amount of resources allocated to the second workload, wherein the execution parameters of the second workload indicate the amount of resources allocated to the second workload.

8. A non-transitory computer-readable storage medium, the computer-readable storage medium including instructions that when executed by a computer, cause the computer to:
determine a similarity of a first workload to a second workload; and
adjust execution of the first workload based on execution parameters of the second workload.

9. The computer-readable storage medium of claim 8, wherein the first workload is represented as a first vector and the second workload is represented as a second vector.

10. The computer-readable storage medium of claim 9, wherein the similarity is based on the first and second vectors.

11. The computer-readable storage medium of claim 9, wherein the similarity is based on at least one of a distance between the first and second vectors in a vector space or a cosine similarity between the first and second vectors.

12. The computer-readable storage medium of claim 9, wherein the instructions further configure the computer to:
compute, by a neural network, the first vector based on telemetry data associated with the execution of the first workload and execution parameters of the first workload.

13. The computer-readable storage medium of claim 12, wherein the first vector comprises an embedding vector.

14. The computer-readable storage medium of claim 8, wherein adjusting the execution of the first workload comprises allocate additional computing resources to the first workload based on an amount of resources allocated to the second workload, wherein the execution parameters of the second workload indicate the amount of resources allocated to the second workload.

15. A computing apparatus comprising:
a processor; and
a memory storing instructions that, when executed by the processor, cause the processor to:
determine a similarity of a first workload to a second workload; and
adjust execution of the first workload based on execution parameters of the second workload.

16. The computing apparatus of claim 15, wherein the first workload is represented as a first vector and the second workload is represented as a second vector.

17. The computing apparatus of claim 16, wherein the similarity is based on the first and second vectors.

18. The computing apparatus of claim 16, wherein the similarity is based on at least one of a distance between the first and second vectors in a vector space or a cosine similarity between the first and second vectors.

19. The computing apparatus of claim 16, wherein the instructions further cause the processor to:
compute, by a neural network, the first vector based on telemetry data associated with the execution of the first workload and execution parameters of the first workload.

20. The computing apparatus of claim 19, wherein the first vector comprises an embedding vector.
